(19) United States
(12) Patent Application Publication
(10) Pub. No.: US 2026/0024458 A1
(43) Pub. Date: Jan. 22, 2026

(54) COMPREHENSION AND ASSESSMENT QUESTION GENERATION USING INTEGRATED PROGRAMMATIC CONTROL AND SPECIALIZED GUIDED AND CONSTRAINED ARTIFICIAL INTELLIGENCE

(71) Applicant: 2hr Learning, Inc., Austin, TX (US)

(72) Inventor: Simon Said, Malta (MA)

(73) Assignee: 2hr Learning, Inc., Austin, TX (US)

(21) Appl. No.: 19/273,093

(22) Filed: Jul. 17, 2025

Related U.S. Application Data
(60) Provisional application No. 63/672,434, filed on Jul. 17, 2024.

(51) Int. Cl. G09B 7/04; G06F 40/279; G06F 40/40; G06N 5/02

(52) U.S. Cl. CPC G09B 7/04; G06F 40/279; G06F 40/40; G06N 5/027

(57) ABSTRACT

An AI-driven question generation system and method for guiding an Artificial Intelligence (AI) engine in generating comprehension questions and assessment questions for users using an online learning platform is disclosed. The method involves receiving educational content including content, grade level, and cognitive level requirements by question generation system. Based on the education content, grade level, and cognitive level requirements, the question generation system selects an appropriate prompt structure from a repository. The collected data is then analyzed to generate insights, which are used to populate the selected prompt structure. The resulting prompts are transferred to the AI engine, guiding it to generate comprehension questions and assessment questions that align with the user's cognitive level and educational standards.

### CROSS-REFERENCE TO RELATED APPLICATION(S)

This application claims the benefit under 35 U.S.C. § 119(e) and 37 C.F.R. § 1.78 of U.S. Provisional Application No. 63/672,434, which is incorporated by reference in its entirety.

This application incorporates by reference the following U.S. patent application Ser. Nos. 19/273,030, 19/273,034, 19/273,036, 19/273,042, 19/273,046, 19/273,050, 19/273,056, 19/273,059, 19/273,062, 19/273,066, 19/273,072, 19/273,077, 19/273,080, 19/273,081, 19/273,085.

### FIELD OF THE INVENTION

The present invention relates in general to the field of electronics, and more specifically to generate comprehension and assessment questions by utilizing artificial intelligence, based on the educational content presented to the user while reading the educational content.

### BACKGROUND OF THE INVENTION

Traditional reading applications offer questions that help the students draw connections between what they are reading, help retain the information, and encourage creative thinking. The comprehension questions can help the students build fluency by focusing on the text they are reading to identify their knowledge about the text. However, these questions are pre-generated and do not dynamically adapt to the content and student's performance or interest. This static nature can lead to a one-size-fits-all approach which may not align according to the needs of an individual.

Traditionally, for the reading applications, the educators manually crafted the questions aligned to the reading content. However, manually generating the questions is time-consuming and energy-intensive for educators. While the questions crafted are tailored to the educational content which effectively targets various cognitive levels and alignment with the educational standards, it is not scalable for large amounts of content or frequent updates. The quality of the questions generated by the educators is inconsistent and lacks personalization.

Conventionally, some tools assist educators in suggesting possible questions based on the text of the reading comprehension. The educator can refine the text or approve it to generate the best possible question for reading comprehension. However, the tools reduce the workload of educators but still require significant input and oversight from the educators. The question generators primarily focus on basic recall questions while lacking the capability to assess higher-order thinking skills. Ultimately both traditional question generators and basic-level question generators share a common pitfall i.e. they do not provide ongoing adaptive personalization according to the students changing needs.

### SUMMARY

In at least one embodiment, a method integrates programmatic control and a guided and constrained Artificial Intelligence (AI) engine to generate comprehension and assessment questions based on educational content for a user. The method includes executing code using one or more processors of a computer system to cause the computer system to perform operations. The operations include receiving the educational content by a question generation system, where the educational content includes content, grade level, and cognitive level requirements. The operations include analyzing the received educational content using a plurality of algorithms of the question generation system to extract key concepts and themes aligned with curriculum standards. The operations include utilizing a text analysis module to categorize the educational content into different subject areas and difficulty levels. The operations include determining one or more levels of understanding required by a cognitive level requirement module for the specific grade level. The operations include generating a prompt via a prompt generator to guide the AI engine in generating comprehension and assessment questions based on the extracted key concepts. The operations include transferring the prompt to the AI engine for generating comprehension and assessment questions based on the extracted key concepts and determined levels of understanding using a comprehension question generator and an assessment question generator. The operations include displaying the generated comprehension and assessment questions by the question generation system to the user on a user interface of an online learning platform.

In at least one embodiment, a system integrates programmatic control and a guided and constrained Artificial Intelligence (AI) engine to generate comprehension and assessment questions based on educational content for a user. The system includes one or more processors of a computer system and a memory, coupled to the one or more processors, storing code that, when executed, causes the computer system to perform operations. The operations include receiving the educational content by a question generation system, where the educational content includes content, grade level, and cognitive level requirements. The operations include analyzing the received educational content using a plurality of algorithms of the question generation system to extract key concepts and themes aligned with curriculum standards. The operations include utilizing a text analysis module to categorize the educational content into different subject areas and difficulty levels. The operations include determining one or more levels of understanding required by a cognitive level requirement module for the specific grade level. The operations include generating a prompt via a prompt generator to guide the AI engine for generating comprehension and assessment questions based on the extracted key concepts. The operations include transferring the prompt to the AI engine to generate comprehension and assessment questions based on the extracted key concepts and determined levels of understanding using a comprehension question generator and an assessment question generator. The operations include displaying the generated comprehension and assessment questions by the question generation system to the user on a user interface of an online learning platform.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary AI-driven comprehension and assessment question generation system based on the educational content of a user.

FIG. 2 depicts an exemplary AI-driven comprehension and assessment question generation process based on the educational content of a user using AI-driven comprehension and assessment question generation system.

FIG. 3 depicts a flowchart disclosing steps to generate dual-level question for the user on an online learning platform.

FIG. 4 depicts an exemplary user interface that discloses different types of genres, and user stories which can be selected by the user for the generation of comprehension and assessment questions.

FIG. 5 depicts a user interface that discloses the collection of the reading passages that are generated by the user.

FIG. 6-7 depicts user interfaces disclosing the ‘guiding questions’ relevant to the reading passage displayed to the user on the online learning platform.

FIG. 8-9 depicts an exemplary user interface disclosing quiz questions which is displayed to the user when the user answers all the guiding questions on the online learning platform.

FIG. 10 depicts a data structure for generating comprehension questions and assessment questions.

FIG. 15 depicts an exemplary network environment in which the system of FIG. 1 and the process of FIG. 2 may be practiced.

FIG. 16 depicts an exemplary computer system.

### DETAILED DESCRIPTION

A question generation system and method guiding an artificial intelligence (AI) engine to generate personalized comprehensions and assessment questions tailored to the complexity of the generated comprehensions and educational levels of a user. The question generation system is operatively coupled to an online learning platform, which the user uses for educational purposes. The question generation system receives educational content from a database. A text analysis module is integrated into the question generation system that categorizes the academic content into different subject areas and difficulty levels. The cognitive level requirement module determines one or more levels of understanding for a specific grade level.

The insights generated by the question generation system are then used by a prompt generator to populate the prompt structure. The prompt generator utilizes machine learning models to create comprehension questions and assessment questions. The generated prompts are then transferred to the AI engine to create comprehension questions and assessment questions using a comprehension question generator and assessment question generator, respectively. The questions are displayed to the user on a user interface of the online learning platform.

The AI-driven question generation system generates comprehension questions and assessment questions which enhance the basic understanding and critical thinking of the user. The AI-driven question generation system benefits educational outcomes by providing a nuanced assessment of student comprehension and analytical skills, thereby supporting adaptive learning paths tailored to individual needs. This dynamic approach fosters deeper engagement and understanding. The real-time generation of comprehension questions and assessment questions leads to targeted skill development.

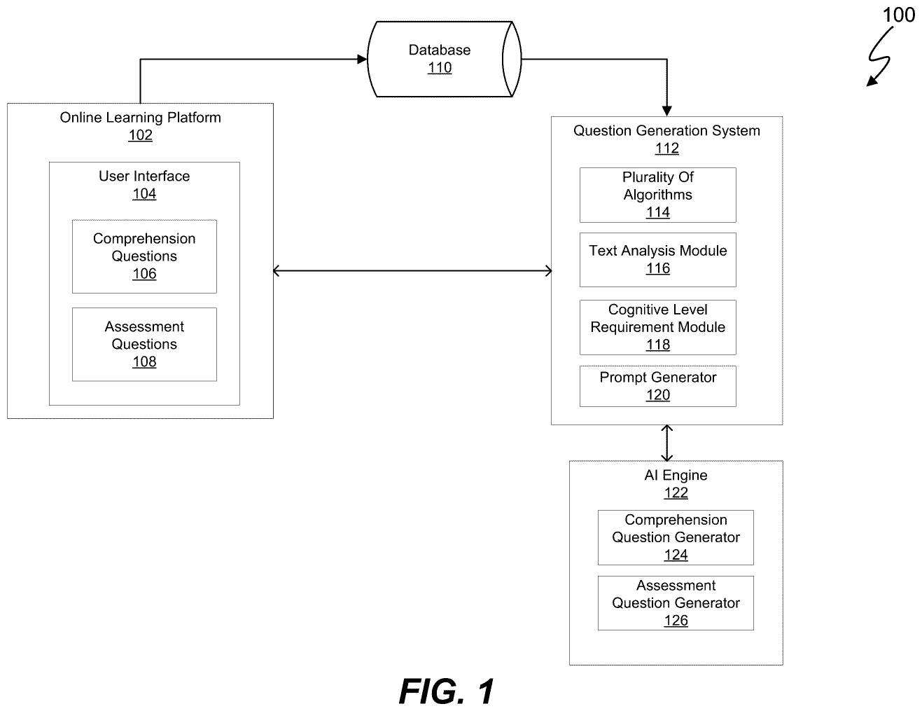

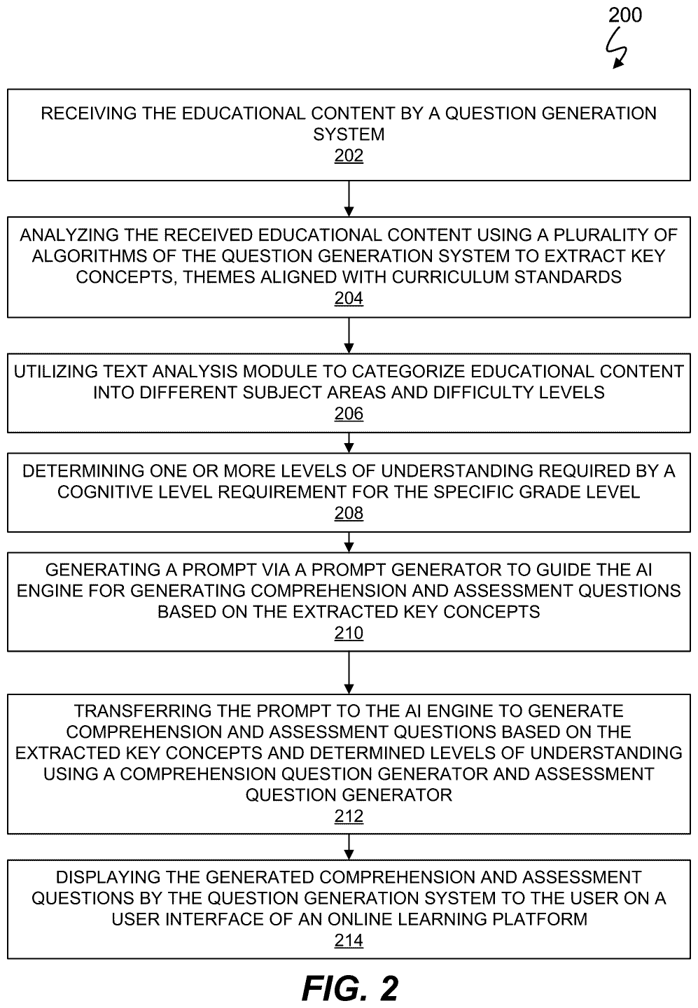

FIG. 1 depicts an exemplary AI-driven comprehension and assessment question generation system 100 based on the educational content relevant to a user. FIG. 2 depicts an exemplary AI-driven comprehension and assessment question generation process 200 based on the educational content relevant to a user using AI-driven comprehension and assessment question generation system 100.

Referring to FIGS. 1 and 2, in operation 202, a question generation system 112 receives educational content relevant to a user's grade level and cognitive level from a database 110.

The question generation system 112 is operatively coupled to an online learning platform and 102 an AI engine 122. The question generation system 112 accesses the details of the user when the user logs onto an online learning platform 102. The details include his age, name, and current grade level. The question generation system 112 guides the AI engine 122 based on the prompts generated by a prompt generator 120.

The question generation system 112 receives educational content from the database 110. The database 110 stores the educational content which is accessed by the question generation system 112. The database 110 supports scalability allowing the online learning platform 102 to store a large amount of content efficiently.

The educational content includes a reading passage. The reading passage is a portion of written work that can either be fictional or non-fictional content. The reading passage aligns with the user's expressed interests and the complexity level that the user can handle. The user's expressed interests are selected based on the interaction of the user with the online learning platform 102. The user interaction includes the selection of the reading passage the user is interested in. For instance, a user interface 104 on the online learning platform 102 presents reading passages belonging to different genres. The user can choose either of the reading passage including ‘mystery’, ‘adventure’, ‘fantasy’, and various others based on his/her interest. The complexity level is defined as the user's understanding of a particular educational content. The educational content is customized to fit the user's preferred genre and themes while matching their current reading capabilities, making the learning experience both engaging and educationally effective. The reading passage can help the users to practice for exams, enhance cognitive thinking, and improve concentration.

In one of the embodiments, the educational content can be generated using Artificial Intelligence as illustratively described in detail in U.S. Provisional Patent Application No. 63/672,430, which is incorporated herein by reference, and in U.S. patent application Ser. No. 19/273,085. In yet another embodiment the educational content can be utilized from a web page, articles available on the internet, by typing in the chat window, or by using ChatGPT. For instance, an article from Harry Potter series 1 can be utilized from the web page by the question generation system 112 to guide the AI engine 122 to produce the desired outcome.

The question generation system 112 also accesses the details of the grade level of the user. In one of the embodiments, the grade level of the user can be accessed from the online learning platform 102 as the user inputs his/her details.

The cognitive level of the user refers to critical thinking, deep interpretation, inference, analysis, and the ability to read and understand the written text. The educational content is aligned with the user's cognitive level. For instance, if a user is studying in grade 6, the question generation system 112 receives educational content related to grade 6 and the user's cognitive level.

As the user engages with the online learning platform 102 the question generation system tracks 112 and analyzes the activities of the user. The real-time data is stored in the database 110 for future reference. The real-time data collection allows the AI engine 122 to dynamically adjust the output.

In operation 204, the question generation system 112 analyzes the received content using a plurality of algorithms 114 to extract key concepts, and themes aligned with curriculum standards.

The plurality of algorithms 114 are integrated within the question generation system 112. The plurality of algorithms 114 analyzes the received educational content from the database 110 to extract key concepts, and themes aligned with educational standards.

The key concepts define fundamental ideas which are relevant to a particular topic. In one of the embodiments, the key concepts can be in the form of keywords, key terms, or phrases relevant to that topic. The themes are defined as the main idea around which the educational content revolves. For instance, the educational content includes the reading passage which is about the survival of animals in the environment of different predators using camouflage. The theme of the passage will be the survival of animals and how can they survive and the key concepts in the passage will revolve around the use of camouflage to survive by blending into the environment. The key concepts and themes are aligned with the educational standards.

The plurality of algorithms 114 analyzes the educational content and extracts the relevant key concepts and themes aligned to the educational standard. The plurality of algorithms analyzes 114 the educational standards to which the educational content belongs. For example, if the user selects their grade level 4th and educational content on food production by plants, the plurality of algorithms 114 will extract key concepts such as chlorophyll, water, food, and oxygen, and the theme will focus on the production of food and how plants make food using photosynthesis.

In operation 206, a text analysis module 116 categorizes educational content into different subject areas and difficulty levels.

The text analysis module 116 is integrated within the question generation system 112 and categorizes the educational content into different subject areas and difficulty levels. The difficulty levels are defined as the complexity of the text and how difficult a text is to read and understand. The text analysis module 116 analyzes the difficulty levels and subject areas of the educational content.

In at least one embodiment, the text analysis module 116 utilizes natural language processing (NLP) to analyze the text of the educational content. The text analysis module 116 collects inputs from the plurality of algorithms 114 about the educational content and key concepts relevant to the educational content. The text analysis module 116 analyzes the text to categorize the educational content based on the data input by the plurality of algorithms 114. The text analysis module 116 utilizes algorithms to break down the content into manageable pieces and assess the key complexities. In at least one embodiment, the text analysis module 116 analyzes the text based on various factors such as sentence length and word length.

The text analysis module 116 analyzes the difficulty level of the educational content, which in this case is a reading passage. In one of the embodiments, a readability score is assigned to the text to assess the difficulty level of the text. For instance, if a user is reading about ‘cell—a functional unit of life’. The reading passage incorporating simple words such as cell, organelle, and nucleus, where the cell is defined by having a nucleus and organelles will be assessed of lower difficulty level. However, a reading passage incorporating words such as cell replication using mitosis where the mitosis is divided into different stages such as prophase, metaphase, anaphase, and others will be assessed of higher difficulty level. The text analysis module 116 analyzes the later sentence to have more word count and higher complexity in words assigning the educational content of higher difficulty level for a higher grade level.

The text analysis module 116 categorizes the educational content into different subject areas. For instance, the key concept of ‘cell’ can fall under two different subjects such as “biology” and “Social Science”. The text analysis module 116 analyzes and categorizes the educational content related to ‘cell’. The text analysis module 116 analyzes the text in the educational content and evaluates to which subject they fit. If a sentence is talking about the ‘cell the fundamental unit of life’, the text analysis module 116 will categorize the educational content describing the cell as the functional unit of life to fall under the biology section.

In operation 208, a cognitive level requirement module 118 determines the understanding at one or more levels for the specific grade level.

The cognitive level requirement module 118 is integrated into the question generation system 112. The cognitive level requirement module 118 classifies the educational content for the specific grade level and targets educational content to different cognitive levels using Bloom's taxonomy.

Bloom's taxonomy is a framework that categorizes cognitive learning into six levels: ‘remembering’, ‘understanding’, ‘applying’, ‘analyzing’, ‘evaluating’, and ‘creating’. Bloom's taxonomy is a framework for classifying educational goals and objectives. The generated questions target different cognitive levels. The generated questions include dual-level questions such as comprehension questions 106 and assessment questions 108 displayed on a user interface 104 of the online learning platform 102.

Bloom's taxonomy promotes higher-level thinking among the users by improving their cognitive strength. The cognitive level requirement module 118 focuses on the ‘understanding’ and ‘analysis’ levels of Bloom's Taxonomy. The analysis level helps in the assessment of the users and whether they can form connections between ideas and utilize their critical thinking skills. The understanding level explains the understanding of the user of a particular key concept.

The cognitive level requirement module 118 utilizes Bloom's Taxonomy and gives a template to a prompt generator to guide AI engine 122 to align the generated questions with the desired cognitive level. The cognitive level requirement module 118 will analyze the interaction of the user with the online learning platform 102 and track the progress of the user. The cognitive level requirement module 118 analyzes if the user can understand and analyze the educational content for a specific grade level. The prompt generator 120 receives the template to guide the AI engine 122 to generate questions.

The cognitive level requirement module 118 utilizes Bloom's Taxonomy and provides input to the prompt generator 120 to identify the cognitive level to be targeted. During the initial reading phase questions recalling basic understanding are generated. As the user interacts with the online learning platform 102 and builds knowledge of the educational content a deeper understanding set of questions is generated.

The cognitive level requirement module 118 takes into account the grade level the user selects on the online learning platform 102 and the interaction of the user with the online learning platform 102. The cognitive level requirement module 118 will now categorize the key concepts according to the grade level the user is currently in.

In operation 210, a prompt generator 120 generates a prompt to guide the AI engine 122 to generate comprehension questions 106 and assessment questions 108 based on the extracted key concepts.

The prompt generates 120 prompts that are provided to the AI engine 122. The prompt generator 120 is operatively coupled to the question generation system 112 which provides prompts based on the input data collected by the question generation system 112. The prompt generator 120 is then used to populate the prompt structure which then further guides the AI engine 122 to generate comprehension questions 106 and assessment questions 108 based on the extracted key concepts for the user using the online learning platform 102.

The comprehension questions 106 test the basic understanding of the user and recall the passage details. The comprehension questions 106 are used to assess the user's understanding and interpretation of the educational content. The comprehension questions check the understanding of the user as they follow a specific lesson plan. The lesson plan includes the educational content the user selects.

The assessment questions 108 test the user's deeper understanding of the educational content. The assessment question 108 requires deeper interpretation, inference, analysis, and critical thinking about the passage, focusing on the “understanding” and “analysis” levels of Bloom's Taxonomy. The assessment questions 108 promotes deep learning of the educational content. The questions align with the higher level of Bloom's Taxonomy and promote a more comprehensive evaluation of the user's understanding.

The comprehension questions 106 and assessment questions 108 are in the form of MCQs. In at least one of the embodiments, the questions may be in the form of true-false, fill-in-the-blank, one-word questions, and so on.

The exemplary prompts transferred by the prompt generator 128 to the AI engine 130 to generate assessment questions are given below:

```
Context
--------
You are an expert question writer for reading comprehension. The correct
answer to a reading comprehension question is something a reader can
support with direct evidence from a Passage. Students are presented with
your generated question as they read to check their understanding of the
Passage.
You write one multiple-choice question that evaluates students'
comprehension of the Passage.
Output Template
--------
All outputs MUST be written with vocabulary and sentence structure that
align with the Lexile of the Passage and are accessible for a student in the
Student Grade.
* Question: A multiple-choice question that tests a student's
comprehension.
* Options: A list of the four answer choices and a correctness marker that
marks the single correct answer as true. Each option will have a unique
letter from A to D as identifier.
* Reading Tip: A one-sentence reading tip for students who incorrectly
answer the comprehension question. This tip focuses on a general strategy
strong readers use that aligns with the question type.
* Correct Answer Explanation: An explanation of the correct answer with
quoted textual evidence. Ensure the quoted text is from the given Passage.
Output Format
------
Format your response in valid JSON format with the following fields:
{
  “question”: “string”,
  “options”: [
    {
      “id”: “string”
      “answer”: “string”,
      “correct”: boolean
    }
  ],
  “correct_answer_explanation”: “string”,
  “reading_tip”: “string”
}
Core Inputs
--------
Student Grade: $studentGrade
Passage: $fictionPassage
```

### Prompt Explanation

The question generation system 112 provides input to the prompt generator 120 to generate a set of comprehension questions 106 while the user is reading a passage. It provides prompts to guide the AI engine 122 to generate comprehension questions 106 based on the user's grade, cognitive level, and understanding of the educational content. The comprehension questions 106 are in the form of MCQ along with their correct answer. The incorrect answer should contain an explanation along with the correct answer along with quoted evidence of the correct answer.

The question generation system 112 tracks the answers given by the user and inputs the prompt generator 120 to guide the AI engine 122 to generate assessment questions 108 as per the answers given by the user to the comprehension questions 106. The output for the comprehension question 106 serves as an input for the assessment questions 108.

The exemplary prompts transferred by the prompt generator 128 to the AI engine 130 to generate assessment questions are given below:

```
Context
------
You are an English Language Arts teacher for the Student Grade with
expertise in crafting passage-based, multiple-choice questions. Your
questions assess a student's mastery of the Passage.
Students have already been assessed on their basic comprehension of the
Passage, so your questions require interpretation, inference, analysis, or
critical examination, ensuring that the correct answers are not explicitly
stated in the text. The questions challenge students to think beyond the
Passage's literal content.
Your questions are effective because they are always written at a slightly
lower reading level than the Passage, ensuring students in the Student
Grade fully understand what is being asked and what the answer options
mean.
Task
------
1. Read the Passage and the associated Comprehension Questions.
2. Analyze the style, structure, and format of the Comprehension
Questions.
3. Identify the key opportunities for evaluating student mastery of the
Passage in the context of the ‘analysis' level of Bloom's Revised
Taxonomy.
4. $taskForPostPassageQuestions
Rules
------
* The vocabulary, sentence structure, and complexity of all questions,
answer options, and explanations must be comprehensible for someone at
a slightly lower reading level than the provided Passage. This ensures
accessibility for students in the Student Grade.
* Ensure that your output is not similar in structure and format to any of
the Comprehension Questions.
* All questions must focus on the ‘understanding’ and ‘analysis' levels of
Bloom's Revised Taxonomy based on the Passage.
* Each question must be unique so that students are not assessed on the
same idea more than once.
* Each question must not reproduce the style, structure, or format of any
of the Comprehension Questions.
* Ensure the vocabulary and sentence structure of all generated text are
comprehensible for someone at a slightly lower reading level than the
provided Passage. For example, a question for a fifth grader might be
worded “What can be inferred about the community's response to Emma's
project,” while the same question for a second grader would be worded,
“What can you tell about how people feel about Emma's idea.″
Output Template
------
- All outputs MUST be written with vocabulary and sentence structure that
are comprehensible for someone at a slightly lower reading level than the
provided Passage and are easily accessible for a student in Student Grade.
* Mastery Questions: multiple choice questions that test a student's
mastery of the Passage.
Output Format
------
Format your response in valid JSON format with the following fields:
{
  ″mastery_questions″: [
      {
    ″question″: ″string″,
    ″options″: [
        {
          ″answer″: ″string″,
          ″explanation″: ″string″,
          ″correct″: boolean
        }
    ]
      }
  ]
}
Core Inputs
------
Student Grade: 6
Passage: Under the blazing summer sun, the small town of Crestfield
buzzed with excitement. Today was the day of the annual football
tournament, and twelve-year-old Alex Parker stood eagerly on the field,
clutching his football helmet in his hands. He was the starting quarterback
for the Crestfield Cougars, and he had been dreaming of this day for
months.
[...]
Alex smiled back, the weight of the game lifting off his shoulders. “We
did it together,” he replied. They had faced a challenge, and through
teamwork and perseverance, they had become legends on that field.
```

### Prompt Explanation

The prompt includes guidelines that guide the AI engine 122 to generate assessment questions 108. The input includes grade level and educational content. The prompts include the generation of assessment question 108, which requires the user to think beyond the passage's literal meaning. The assessment questions 108 are generated based on Bloom's taxonomy. The Bloom taxonomy targets comprehension questions 106 and assessment questions 108 to be of a desired cognitive level. In some embodiments, the assessment questions test the mastery of the user for the topic covered in the passage.

In operation 212, the prompt generator 120 transfers the generated prompt to the AI engine 122 to generate comprehension questions 106 and assessment questions 108 based on the extracted key concepts and determined levels of understanding using a comprehension question generator 124 and assessment question generator 126.

The prompt generator 120 is operatively coupled to the AI engine 122 and transfers the generated prompts to the AI engine 122 to guide the AI engine 122 to generate comprehension questions 106 and assessment questions 108 using a comprehension question generator 124 and assessment question generator 126. The AI engine 122 is operatively coupled to the question generation system 112.

The AI engine 122 utilizes natural language processing (NLP) and machine learning algorithms to understand and interpret AI-generated educational content at multiple cognitive levels. The machine learning models are trained on a large dataset of educational content and questions. These models learn patterns and relationships between content and question types, enabling them to generate relevant and cognitively appropriate questions.

The comprehension question generator 124 is integrated into the AI engine 122. The comprehension question generator 124 is operatively coupled to the question generation system 112. The comprehension question generator 124 receives input from the prompt generator 120 to generate an initial set of comprehension questions 106 that align with the educational curriculum standards' key concepts and educational goals.

The assessment question generator 126 is operatively coupled to the AI engine 122. The assessment question generator 126 is operatively connected to the question generation system 112. The assessment question generator 126 receives input from the prompt generator 120 to generate the assessment questions 108, which require a deeper understanding level of the educational content and target different cognitive levels.

The output comprehension question response along with the MCQ questions, answers, and explanation to incorrect responses using the comprehension question generator 124 is given below:

```
{
  “question”: “Why is Alex Parker excited at the start of the football
tournament?”,
  “options”: [
    {
      “id”: “A”,
      “answer”: “Because he enjoys playing football.”,
      “correct”: false
    },
    {
      “id”: “B”,
      “answer”: “Because it is his first time playing quarterback.”,
      “correct”: false
    },
    {
      “id”: “C”,
      “answer”: “Because he has been dreaming of this day for months.”,
      “correct”: true
    },
    {
      “id”: “D”,
      “answer”: “Because his team is very experienced and skillful.”,
      “correct”: false
    }
  ],
  “correct_answer_explanation”: “The correct answer is C. The passage
states, ‘He was the starting quarterback for the Crestfield Cougars, and he
had been dreaming of this day for months.’”,
  “reading_tip”: “Strong readers often look for specific sentences or
phrases in the text that directly answer the question.”
}
```

### Prompt Explanation

The comprehension question generator 124 generates a set of comprehension questions 106 along with the possible correct answers. The correct answer explanation is also given along with a reading tip.

As the user attempts the comprehension questions 106, a set of assessment questions 108 are generated.

The output assessment question response along with the MCQ questions, answers, and explanation to incorrect responses using the comprehension question generator is given below:

```
{
  “mastery_questions”: [
    {
    “question”: “What does Alex's decision to change their strategy show
about his character?”,
    “options”: [
    {
    “answer”: “He is willing to adapt and take risks for the team's
benefit.”,
    “explanation”: “Alex changes the strategy to involve Jason more,
showing he can think on his feet and make decisions for his team's
success.”,
    “correct”: true
    },
    {
    “answer”: “He doubts the abilities of his other teammates.”,
    “explanation”: “While Alex does change the strategy, there is no
evidence in the text to suggest he doubts his teammates' abilities.”,
    “correct”: false
    },
    {
    “answer”: “He fears losing without Marcus.”,
    “explanation”: “Although Alex is concerned about Marcus's injury,
his actions show determination to find a way to win, not just fear of
losing.”,
    “correct”: false
    },
    {
    “answer”: “He prefers playing with Jason over anyone else.”,
    “explanation”: “Alex's decision is strategic to win the game, not
based on personal preference for playing with Jason.”,
    “correct”: false
    }
    ]
    },
    ...
  ]
}
```

### Prompt Explanation

The assessment question generator 126 generates assessment questions based on the input given by the prompt generator 120 to the AI engine 122. Assessment question 108 consists of an MCQ along with a correct answer, an explanation for the correct answer, and incorrect answers. Also, the assessment questions 108 should not be similar to the comprehension questions 108.

The comprehension question generator 124 and assessment question generator 126 utilize sequence-to-sequence models to generate questions based on the input content given by the prompt generator 120 and the desired cognitive level. The sequence-to-sequence model takes in the inputs from the prompt generator 120. The sequence-to-sequence model processes the input and creates the summary of key concepts. The summary of the key concepts is utilized by the comprehension question generator 124 and assessment question generator 126 to generate questions.

The AI engine 122 utilizes a ranking model to evaluate and select the relevant and high-quality comprehension questions 106 and assessment questions 108 amongst the generated comprehension questions 106 and assessment questions 108, respectively. The ranking model helps to find the most relevant question from the pool of questions, which is aligned with the educational content and the user's cognitive level.

The AI engine 122 must accurately interpret the educational content's complexity and relevance to ensure question quality. The generated questions must adhere to the educational standards without directly replicating the text content of the standards. The question generation system 112 can be used to adjust the complexity of the questions. The AI engine 122 ensures the generated questions are challenging yet appropriate for the grade level.

In operation 214, the question generation system 112 displays the generated comprehension questions 106 and assessment questions 108 on a user interface 104 of the online learning platform 102.

The online learning platform 102 presents a set of comprehension questions 106 and assessment questions 108 to the user on the user interface 104. Comprehension question 106 checks the understanding of the user of the key concepts as they read the passage. Assessment question 108 is a high-order question to formulate a deeper understanding of the user. The generated questions are aligned with the user's educational goals.

Once the comprehension questions 106 and assessment questions 108 are generated, it is stored in the database 110 for easy retrieval in the future. This storage ensures the user can revisit previous passages, review their progress, and track their development over time. The cloud-based approach also supports scalability, enabling the online learning platform 102 to handle a large volume of content and users efficiently.

The prompt generator 120 utilizes asynchronous processing techniques (e.g., async/await) and Amazon Simple Queue Service (SQS) to handle asynchronous processing of content analysis and question generation tasks. This ensures that the system remains responsive during potentially time-consuming operations and can handle multiple requests concurrently. The prompt generator 120 handles the errors and retry mechanisms to handle potential failures or timeouts during the comprehension questions 106 and assessment questions 108 generation process.

Provided below is pseudocode for the question-generation process:

```
generate_article_questions(lexile, grade, interest, dataSource,
newArticleId, userId):
    # Generate the educational article
    article = generate_article(lexile, grade, interest)
    # Generate comprehension questions for the article
    comprehension_questions =
generate_comprehension_questions(article.text, grade)
    # Generate assessment questions for the article
  assessment_questions = generate_assessment_questions(article.text,
  grade)
    # Save the generated questions and image prompt to the database
    save_to_database(dataSource, newArticleId, userId, article,
comprehension_questions, assessment_questions)
    return article
```

### Explanation:

The question generation system 112 takes into account the educational content and grade level to generate comprehension questions 106 and assessment questions 108 using an AI engine 122. The generated questions are stored in the database 110 for future reference.

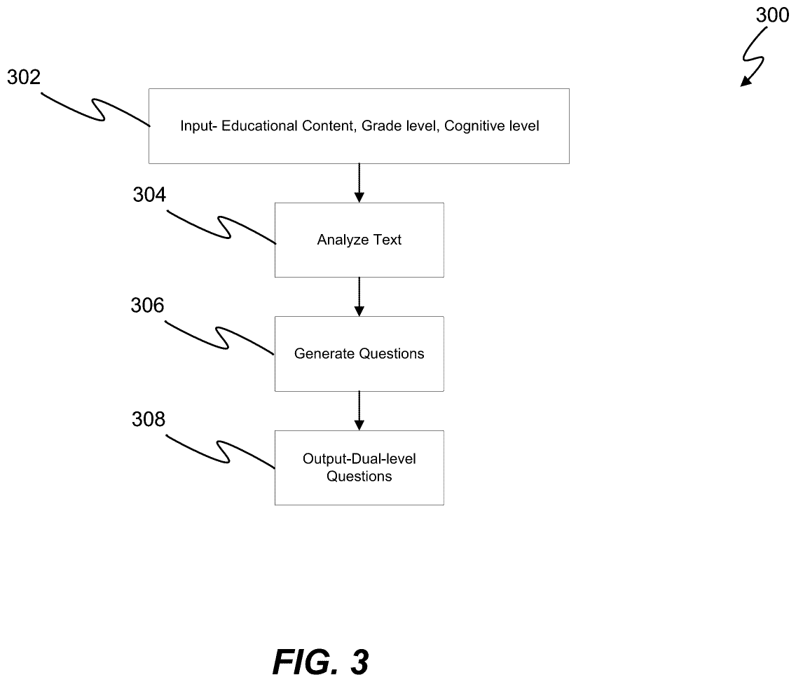

FIG. 3 depicts a flowchart 300 disclosing steps to generate dual-level question 308 for the user on an online learning platform 102.

Initially, the user logs onto the online learning platform 102. The process is initiated by the inputs of educational content, grade level, and cognitive level stored in the database 110 The educational content stored in the database 110 is fed to the question generation system 112. The education content is aligned with the grade level and cognitive level of the user. The collected data is then utilized by the text classification module 116 to analyze the text of the educational content to extract key concepts and themes from the educational content.

The inputs are then fed to prompt generator 120 to guide the AI engine 122 to generate questions 306 and the output-dual-level questions 308 generation to enhance both the basic understanding and critical thinking of the user. The dual-level questions include the comprehension questions 106 and the assessment questions 108 which are presented to the user on the user interface 104 of the online learning platform 102.

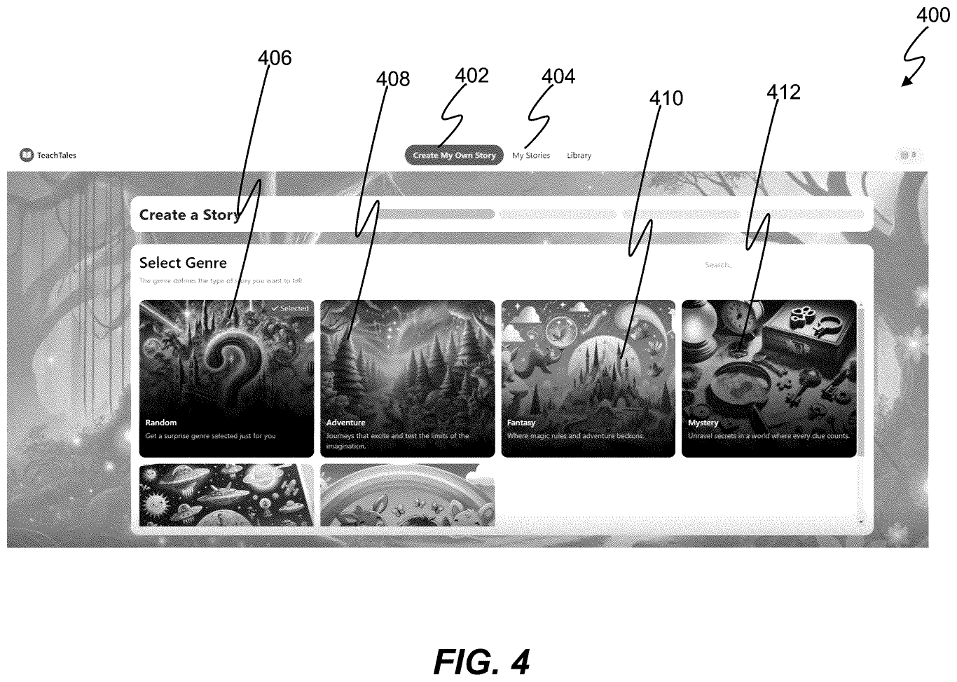

FIG. 4 depicts an exemplary user interface 400 that discloses different types of genres and user stories, which can be selected by the user for the generation of comprehension questions 106 and assessment questions 108.

The user interface 400 shows a tab ‘Create my own Story’ 402, clicking on which multiple genres are made available to the user. The user can select the genre of his/her choice by clicking on corresponding tabs. For instance, the user can select genres like ‘Adventure’ 408, ‘Fantasy’ 410, ‘Mystery’412 and so on. Interestingly, if the user is confused while selecting the genres, the user can click on the tab ‘Random’406, which allows random selection of any of the genres that will not be based on the user's interests. The stories represent the educational content for the different genres which is stored in the database 110.

The user interface 400 shows a tab “My stories” 404 and each user has his/her profile. For each user different set of educational content is stored in the database, which can be accessed by the question generation system 112 to generate comprehension questions 106 and assessment questions 108. The user can click on the “My stories” 404 tabs to have access to different stories or educational content.

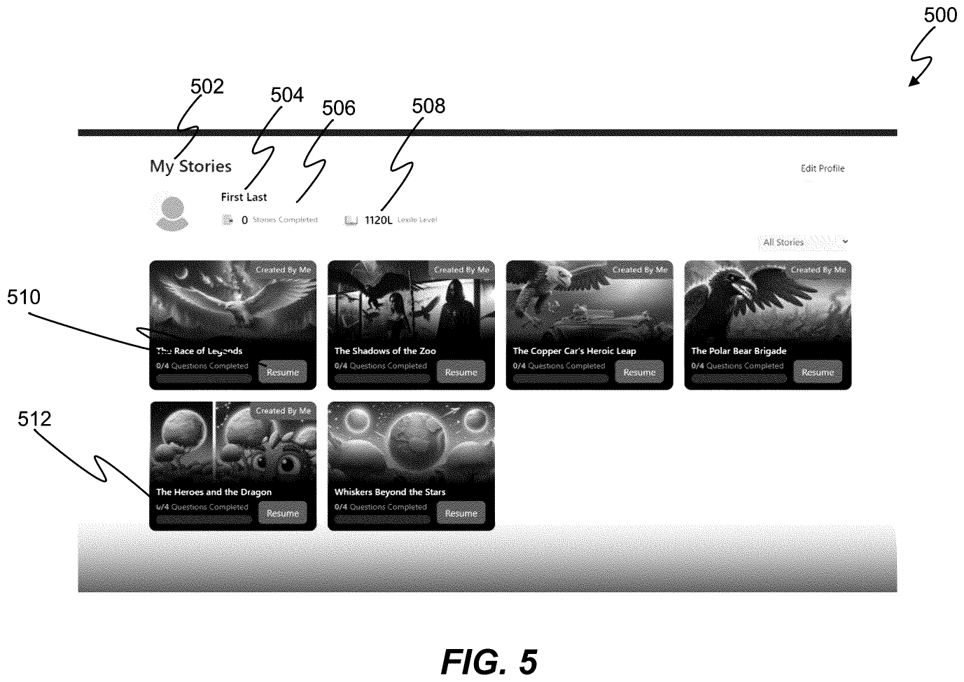

FIG. 5 depicts a user interface 500 that discloses the collection of the reading passages that are generated by the user.

After logging in using the user interface 400, the user gets onto user interface 500 where he/she can select the tab ‘My Stories’ 502 to see the collection of all the reading passages generated to date. The tab ‘First Last’ 504 discloses the name of the user, following which tabs like ‘Stories Completed’ 506, and ‘Lexile Level’ 508 provide details of the passages completed by the user and lexile level or the reading level of the user based on which the passage is generated respectively. The user can click on the tab ‘Resume’ 510 to resume reading the passages where they have left if the passage is left incomplete. The tab ‘0/4 questions completed’ 512 represents the number of questions attempted by the user while reading the passage. The user can click on any reading passage to attempt the generated questions to build an understanding of the reading passage at a deeper level.

The ‘Lexile Level’ 508 of the user is defined as the user's ability to understand the written material. The ‘Lexile Level’ 508 is often measured by a Lexile score. This information is useful to match the passages to the user's comprehension level, ensuring that the educational content is appropriately challenging to the user.

The ‘Lexile Level’ 508 can be inputted by the user on the user interface 104 of the online learning platform 102. The ‘Lexile Level’ also updates as the user interacts with the reading passage.

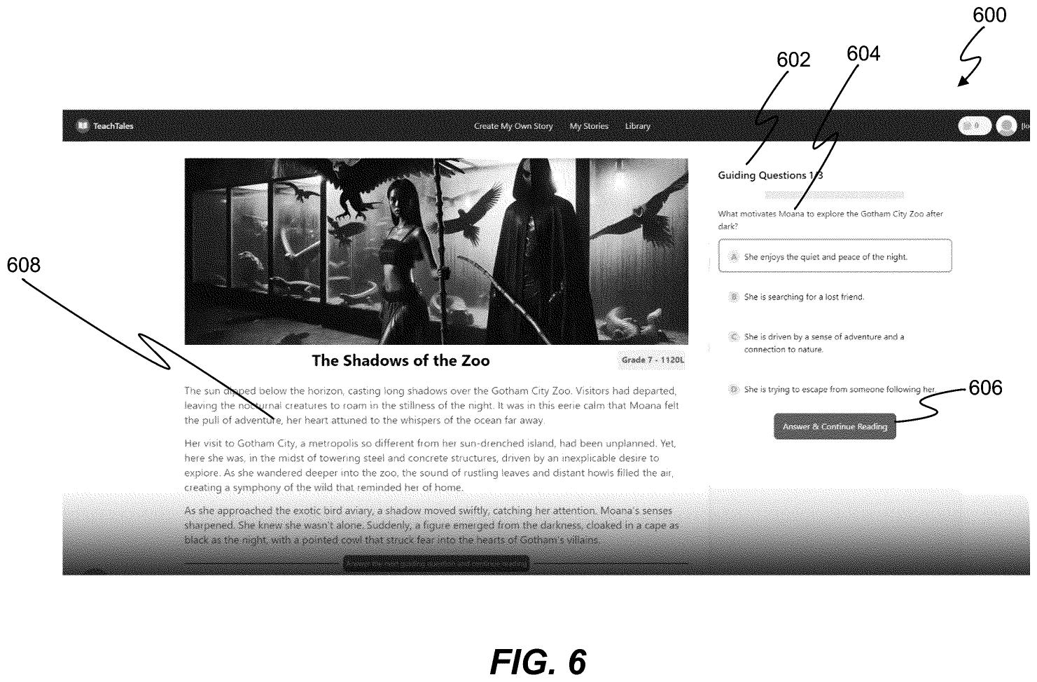

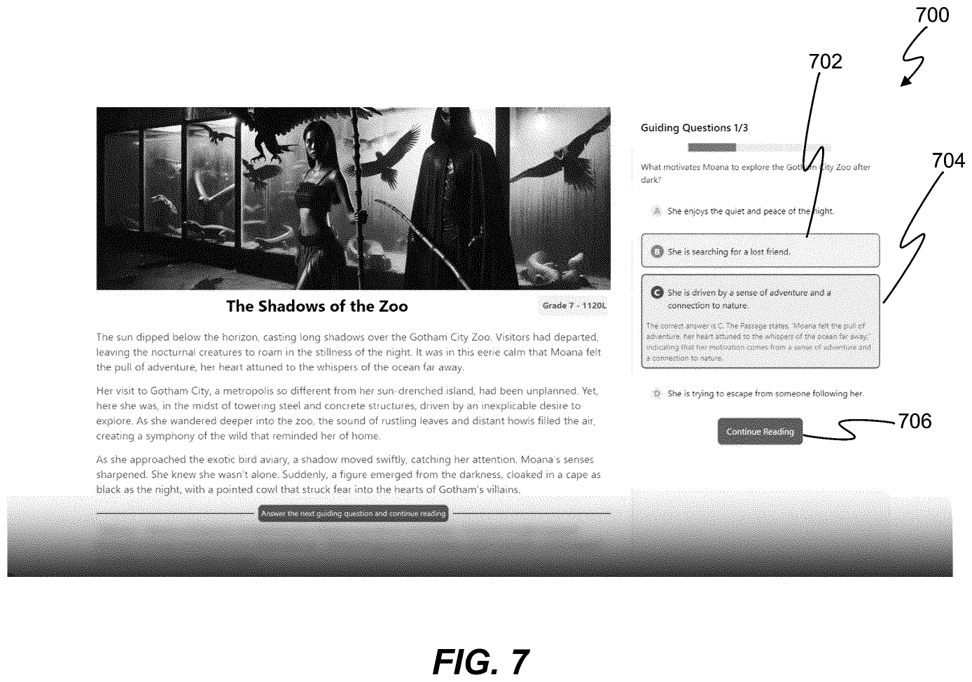

FIG. 6-7 depicts user interfaces 600 and 700 disclosing the ‘guiding questions’ 602 relevant to the reading passage displayed to the user on the online learning platform 102.

The user interface 600 shows guiding question 602. The guiding questions 602 are defined as comprehension questions 106 displayed to the user on the online learning platform 102. The guiding questions 602 help the user to understand the literal meaning of the reading passage. The guiding questions 602 are in the form of MCQs 604. The user can answer the question such that answering them correctly or incorrectly will allow the user to unlock reading passage 608. As the user answers the question the user can click on the tab ‘Answer and Continue Reading’ 606 to unlock the reading passage 608.

The user interface 700 discloses the response given by the user to the guiding question 602 on the online learning platform 102.

The user gives the response to the guiding question displayed on the online learning platform. If the user answers the question incorrectly 702, the box displaying the response selected by the user will turn red. A correct answer 704 will be highlighted in green color along with the explanation of the answer for the reason it is correct. The user can click on the tab ‘Continue Reading’ 706 to unlock the reading passage.

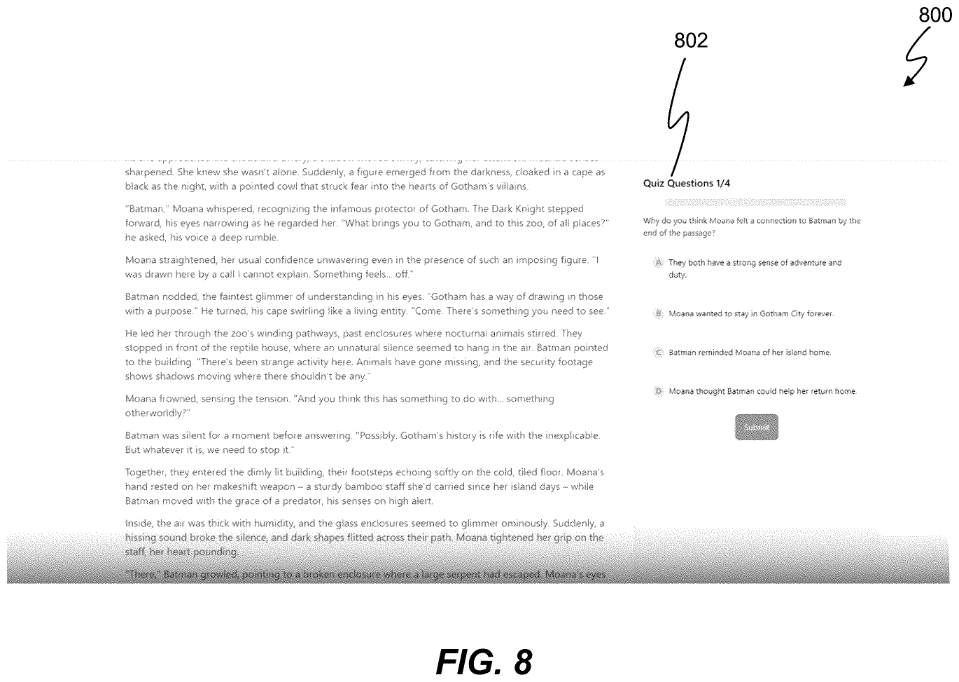

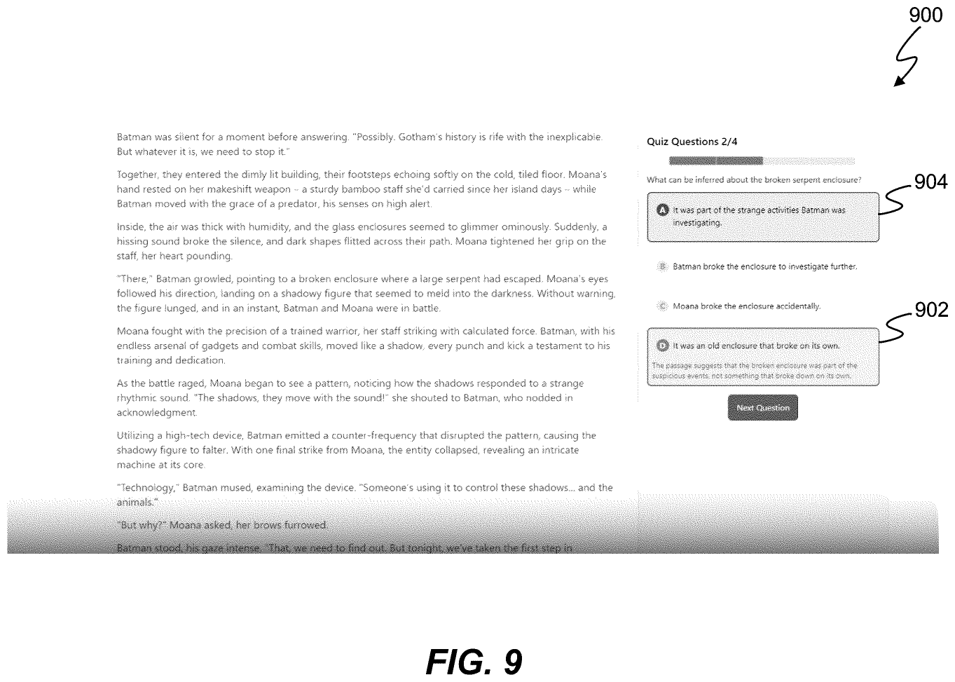

FIG. 8-9 depicts an exemplary user interface 800 disclosing quiz question 802, which is displayed to the user when the user answers all the guiding questions 602 via the online learning platform 102.

The user interface 800 discloses the quiz questions 802. The quiz questions 802 are defined as assessment questions 108 which require a deeper understanding of the reading passage. The quiz questions 802 determine the critical thinking of the user. The quiz questions 802 are presented to the user in the form of MCQs.

The user interface 900 discloses the response given by the user to the quiz questions 802. The user can click on any option to respond to the question. If the user answers the question incorrectly 902, the answer will be highlighted in red color indicating the response given by the user is incorrect. An explanation is given along with the incorrect question to highlight why the answer is incorrect. The correct answer 904 is highlighted in green color. As the user answers the questions the mastery level of the user is updated in the knowledge graph of the user on the online learning platform 102. The generated questions help the user to enhance basic understanding and critical thinking.

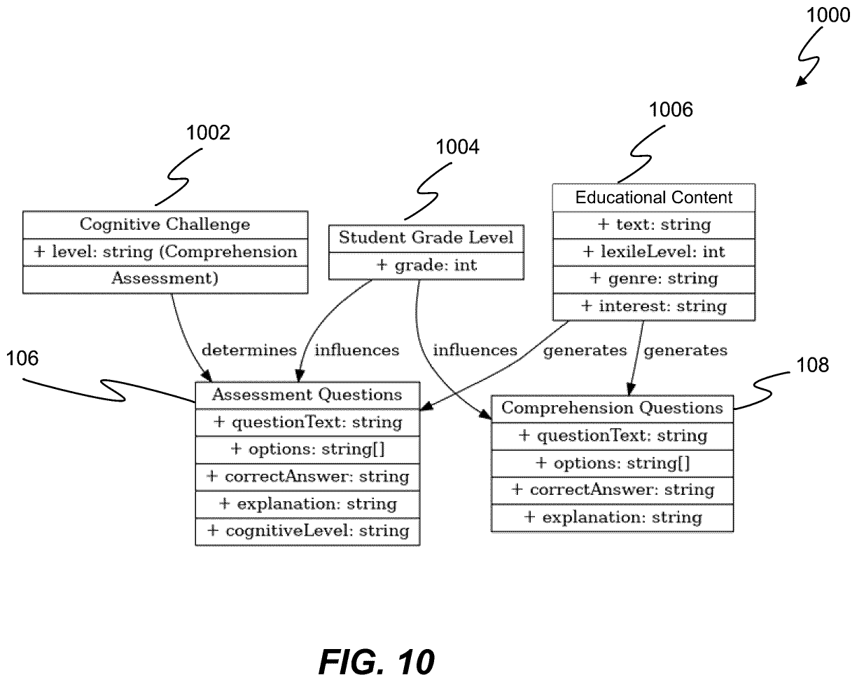

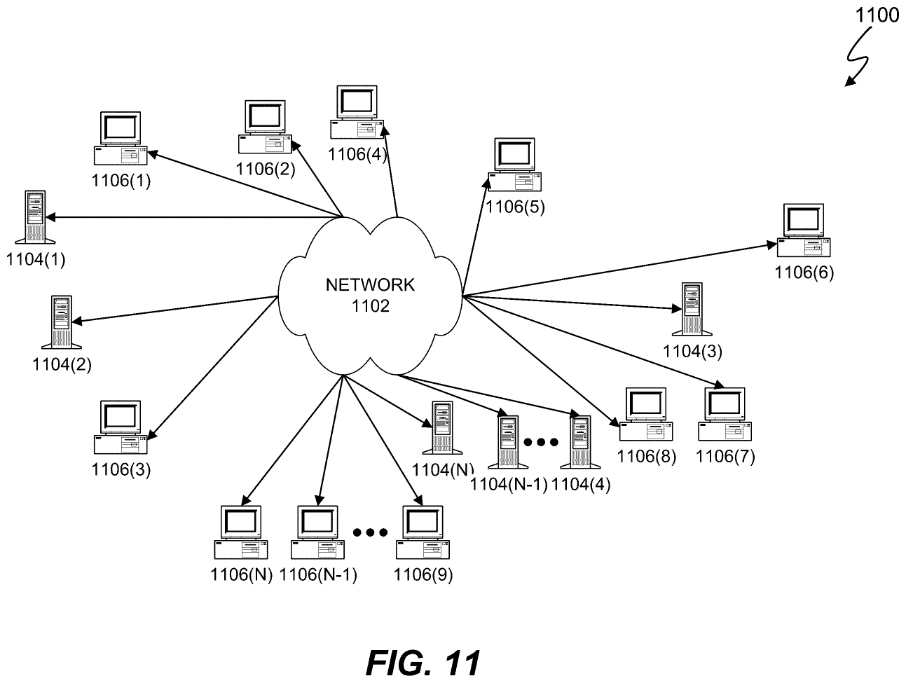

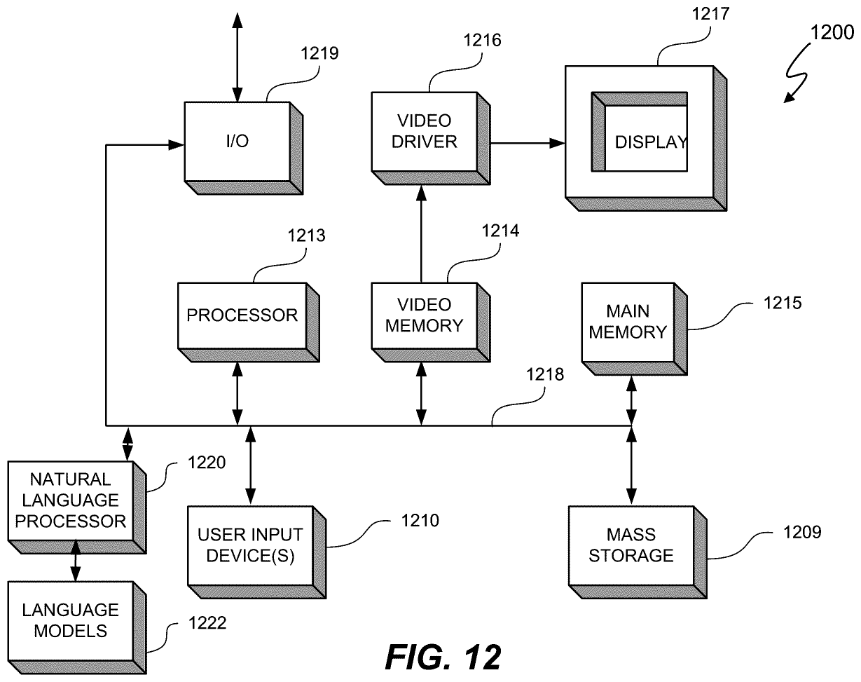

FIG. 10 depicts a data structure 1000 for generating comprehension questions 106 and assessment questions 108.

The data structure 1000 depicts using different nodes to generate comprehension question 106 and assessment question 108. The data structure 1000 includes three nodes which lead to the generation of comprehension questions 106 and assessment questions 108, namely ‘Cognitive challenge’ 1002, ‘Student grade level’ 1004, and ‘Educational Content’ 1006.

A ‘Cognitive Challenge’ node 1002 includes the comprehension assessment of the user. The comprehension assessment evaluates the ability of the user to understand the educational content. The comprehension assessment may differ for each user. The ‘Cognitive Challenge’ 1002 determines the type of comprehension questions 106 and assessment questions 108 displayed to the user via the online learning platform 102. The cognitive level of the user is important for the generation of comprehension questions 106 and assessment questions 108.

A ‘student grade level’ 1004 includes the information of the grade the user is currently in. The ‘Student grade level’ 1004 influences the generation of comprehension questions 106 and assessment questions 108. The grade level may or may not entirely control the type of questions generated. The ‘student grade level’ 1004 will not entirely affect the question types. For instance, if the user has a more cognitive understanding of the key concept, the questions will be updated based on the cognitive level of the user.

The ‘education content’ node 1006 leads to the generation of comprehension questions 106 and assessment questions 108. The ‘educational content’ 1006 includes text, lexile level, genre, and interest. The interest incorporates the specific topics or themes the user is particularly interested in such as fictional or non-fictional stories. The text incorporates the reading passage which aligns with the educational curriculum of the user. The Lexile level determines the type of educational content that will be generated. The user can also decide the type of genre he/she wants the educational content. All these factors control the generation of educational content which is then stored in the database 110 for future reference. The stored educational content can be used to generate comprehension questions 106 and assessment questions 108.

The ‘comprehension questions’ 106 node includes the question text which is in the form of MCQs, along with the options for that generated question. The comprehension question node 106 also includes a correct answer along with an explanation of why the answer is correct.

The ‘assessment questions’ 108 node includes the question text along with the options and correct answer and an explanation of the incorrect answer. Assessment questions 108 are personalized questions based on the student's cognitive level. Assessment questions 108 requires deeper skills such as inferential analysis and critical thinking.

FIG. 11 is a block diagram illustrating a network environment in which AI-driven comprehension and assessment question generation system 100 and AI-driven comprehension and assessment question generation process 200 may be practiced. Network 1102 (e.g. a private wide area network (WAN) or the Internet) includes a number of networked server computer systems 1104(1)-(N) that are accessible by client computer systems 1106(1)-(N), where N is the number of server computer systems connected to the network. Communication between client computer systems 1106(1)-(N) and server computer systems 1104(1)-(N) typically occurs over a network, such as a public switched telephone network over asynchronous digital subscriber line (ADSL) telephone lines or high-bandwidth trunks, for example communications channels providing T1 or OC3 service. Client computer systems 1106(1)-(N) typically access server computer systems 1104(1)-(N) through a service provider, such as an internet service provider (“ISP”) by executing application specific software, commonly referred to as a browser, on one of client computer systems 1106(1)-(N).

Client computer systems 1106(1)-(N) and/or server computer systems 1104(1)-(N) are specialized computer programmed to improve conventional computer systems to implement and utilize the AI-driven comprehension and assessment question generation system 100 and AI-driven comprehension and assessment question generation process 200. The type of computer system that can be specially programmed to implement and utilize the AI-driven comprehension and assessment question generation system 100 and AI-driven comprehension and assessment question generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the AI-driven comprehension and assessment question generation system 100 and AI-driven comprehension and assessment question generation process 200 can be implemented using code stored in a tangible, non-transient computer-readable medium and executed by one or more processors. In at least one embodiment, the AI-driven comprehension and assessment question generation system 100 and AI-driven comprehension and assessment question generation process 200 can be implemented completely in hardware using, for example, logic circuits and other circuits including field programmable gate arrays.

Embodiments of the AI-driven comprehension and assessment question generation system 100 and AI-driven comprehension and assessment question generation process 200 can be implemented on a computer system such as a special-purpose, special-programmed computer 1200 illustrated in FIG. 12. Input user device(s) 1210, such as a keyboard and/or mouse, are coupled to a bi-directional system bus 1218. The input user device(s) 1210 are for introducing user input to the computer system and communicating that user input to processor 1213. The computer system of FIG. 12 generally also includes a non-transitory video memory 1214, non-transitory main memory 1215, and non-transitory mass storage 1209, all coupled to bi-directional system bus 1218 along with input user device(s) 1210 and processor 1213. The mass storage 1209 may include both fixed and removable media, such as a hard drive, one or more CDs or DVDs, solid state memory including flash memory, and other available mass storage technology. Bus 1218 may contain, for example, 32 of 64 address lines for addressing video memory 1214 or main memory 1215. The system bus 1218 also includes, for example, an n-bit data bus for transferring DATA between and among the components, such as CPU 1209, main memory 1215, video memory 1214 and mass storage 1209, where “n” is, for example, 32 or 64. Alternatively, multiplex data/address lines may be used instead of separate data and address lines.

I/O device(s) 1219 may provide connections to peripheral devices, such as a printer, and may also provide a direct connection to a remote server computer systems via a telephone link or to the Internet via an ISP. I/O device(s) 1219 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1209, into main memory 1215 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1213, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1215 is comprised of dynamic random access memory (DRAM). Video memory 1214 is a dual-ported video random access memory. One port of the video memory 1214 is coupled to video amplifier 1216. The video amplifier 1216 is used to drive the display 1217. Video amplifier Y16 is well known in the art and may be implemented by any suitable means. This circuitry converts pixel DATA stored in video memory 1214 to a raster signal suitable for use by display 1217. Display 1217 is a type of monitor suitable for displaying graphic images.

The computer system described above is for purposes of example only. The AI-driven comprehension and assessment question generation system 100 and AI-driven comprehension and assessment question generation process 200 may be implemented in any type of computer system or programming or processing environment. It is contemplated that the AI-driven comprehension and assessment question generation system 100 and AI-driven comprehension and assessment question generation process 200 might be run on a stand-alone computer system, such as the one described above. The AI-driven comprehension and assessment question generation system 100 and AI-driven comprehension and assessment question generation process 200 might also be run from a server computer systems system that can be accessed by a plurality of client computer systems interconnected over an intranet network. Finally, the AI-driven comprehension and assessment question generation system 100 and AI-driven comprehension and assessment question generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method that integrates programmatic control and a guided and constrained Artificial Intelligence (AI) engine to generate comprehension and assessment questions based on educational content for a user, the method comprising:
executing code using one or more processors of a computer system to cause the computer system to perform operations comprising:
receiving the educational content by a question generation system, wherein the educational content includes content, grade level, and cognitive level requirements;
analyzing the received educational content using a plurality of algorithms of the question generation system to extract key concepts, and themes aligned with curriculum standards;
utilizing text analysis module to categorize the educational content into different subject areas and difficulty levels;
determining one or more levels of understanding required by the cognitive level requirement module for the specific grade level
generating a prompt via a prompt generator to guide the AI engine in generating comprehension and assessment questions based on the extracted key concepts; and
transferring the prompt to the AI engine for generating comprehension and assessment questions based on the extracted key concepts and determined levels of understanding using a comprehension question generator and assessment question generator; and
displaying the generated comprehension and assessment questions by the question generation system to the user on a user interface of an online learning platform.

2. The method of claim 1 wherein executing code using one or more processors of a computer system to cause the computer system to perform operations comprising:
breaking down the educational content into manageable pieces using a text analysis algorithm;
identifying key concepts, themes, and essential details within the content;
assessing the complexity of the content relative to the grade level and cognitive requirements; and
utilizing a question generation algorithm to formulate questions that align with the identified key concepts and educational goals specified by the educational curriculum standards.

3. The method of claim 1 wherein executing code using one or more processors of a computer system to cause the computer system to perform operations comprising:
utilizing a sequence-to-sequence model to generate the comprehension and assessment questions based on the input content and desired cognitive level.

4. The method of claim 1 wherein executing code using one or more processors of a computer system to cause the computer system to perform operations comprising:
utilizing a ranking model to evaluate and select the relevant and high-quality comprehension and assessment questions amongst the generated comprehension and assessment questions.

5. The method of claim 1 wherein executing code using one or more processors of a computer system to cause the computer system to perform operations comprising:
incorporating Bloom's Taxonomy for classifying educational goals and objectives to ensure that the generated comprehension and assessment questions target different cognitive levels of the user.

6. The method of claim 1 wherein the prompt generator utilizes asynchronous processing techniques Simple Queue Service (SQS) to handle asynchronous processing of content analysis and question generation tasks to ensure the question generation system remains responsive during potentially time-consuming operations to handle multiple requests of the user concurrently.

7. The method of claim 1 wherein the prompt generator includes error handling and retry mechanisms to handle potential failures or timeouts during the comprehension and assessment questions generation process.

8. The method of claim 1 wherein wherein executing code using one or more processors of a computer system to cause the computer system to perform operations comprising:
storing the educational content and generated comprehension and assessment questions in a database.

9. A system that integrates programmatic control and a guided and constrained Artificial Intelligence (AI) engine to generate comprehension and assessment questions based on educational content for a user comprising:
one or more processors of a computer system; and
a memory, coupled to the one or more processors, storing code that when executed causes the computer system to perform operations comprising:
receiving the educational content by a question generation system, wherein the educational content includes content, grade level, and cognitive level requirements;
analyzing the received educational content using a plurality of algorithms of the question generation system to extract key concepts, and themes aligned with curriculum standards;
utilizing text analysis module to categorize educational content into different subject areas and difficulty levels;
determining one or more levels of understanding required by the cognitive level requirement module for the specific grade level
generating a prompt via a prompt generator to guide the AI engine for generating comprehension and assessment questions based on the extracted key concepts; and
transferring the prompt to the AI engine to generate comprehension and assessment questions based on the extracted key concepts and determined levels of understanding using a comprehension question generator and assessment question generator; and
displaying the generated comprehension and assessment questions by the question generation system to the user on a user interface of an online learning platform.

10. The system of claim 9 wherein the memory stores code that when executed causes the computer system to further perform operations comprising:
breaking down the educational content into manageable pieces using a text analysis algorithm;
identifying key concepts, themes, and essential details within the content;
assessing the complexity of the content relative to the grade level and cognitive requirements; and
utilizing a question generation algorithm to formulate questions that align with the identified key concepts and educational goals specified by the educational curriculum standards.

11. The system of claim 9 wherein the memory stores code that when executed causes the computer system to further perform operations comprising:
utilizing a sequence-to-sequence model to generate the comprehension and assessment questions based on the input content and desired cognitive level.

12. The system of claim 9 wherein the memory stores code that when executed causes the computer system to further perform operations comprising:
utilizing a ranking model to evaluate and select the relevant and high-quality comprehension and assessment questions amongst the generated comprehension and assessment questions.

13. The system of claim 9 wherein the memory stores code that when executed causes the computer system to further perform operations comprising:
incorporating Bloom's Taxonomy for classifying educational goals and objectives to ensure that the generated comprehension and assessment questions target different cognitive levels of the user.

14. The system of claim 9 wherein the prompt generator utilizes asynchronous processing techniques Simple Queue Service (SQS) to handle asynchronous processing of content analysis and question generation tasks to ensure the question generation system remains responsive during potentially time-consuming operations to handle multiple requests of the user concurrently.

15. The system of claim 9 wherein the prompt generator includes error handling and retry mechanisms to handle potential failures or timeouts during the comprehension and assessment questions generation process.

16. The system of claim 9 wherein storing the educational content and generated comprehension and assessment questions in a database.
